(19) United States
(12) Patent Application Publication
(10) Pub. No.: US 2026/0168302 A1
(43) Pub. Date: Jun. 18, 2026

(54) CENTER HINGE AND REFRIGERATOR HAVING THE CENTER HINGE

(71) Applicant: LG ELECTRONICS INC., Seoul (KR)

(72) Inventors: Jungmi KIM, Seoul (KR); Yoomin PARK, Seoul (KR)

(73) Assignee: LG ELECTRONICS INC., Seoul (KR)

(21) Appl. No.: 19/406,128

(22) Filed: Dec. 2, 2025

(30) Foreign Application Priority Data
Dec. 17, 2024 (KR) 10-2024-0187977

(51) Int. Cl. E05D 7/081; F25D 23/02

(52) U.S. Cl. CPC E05D 7/081; F25D 23/028; E05D 2700/10; E05Y 2900/31; F25D 2323/024

(57) ABSTRACT

The present invention relates to a center hinge and a refrigerator provided with the center hinge, and a center hinge according to an embodiment of the present invention is comprising a hinge bracket fixedly mounted to a cabinet of a refrigerator that is opened and closed by an upper door and a lower door; an upper link module disposed at an upper portion of the hinge bracket, the upper link module comprising a plurality of links and configured to connect the hinge bracket and the upper door to rotate the upper door; a lower link module disposed at a lower portion of the hinge bracket, the lower link module comprising a plurality of links and configured to connect the hinge bracket and the lower door to rotate the lower door; a spacer provided in the hinge bracket and on which the upper link module and the lower link module are mounted; and a first hinge shaft passing through the hinge bracket, the upper link module, the lower link module, and the spacer, and configured to enable rotation of the upper link module and the lower link module, wherein the upper link module and the lower link module are inserted into the spacer in a state spaced apart from the hinge bracket.

### CROSS-REFERENCE TO RELATED APPLICATIONS

The present application claims priority under 35 U.S.C. 119 and 35 U.S.C. 365 to Korean Patent Application No. 10-2024-0187977 (Dec. 17, 2024), which is hereby incorporated by reference in its entirety.

### BACKGROUND

The present disclosure relates to a center hinge and a refrigerator having the center hinge.

In general, a refrigerator is a household appliance that allows food to be stored at a low temperature within an internal storage compartment shielded by a door. To this end, the refrigerator is configured to maintain stored food in an optimal state by cooling the interior of the storage compartment using cold air generated through heat exchange with a refrigerant circulating in a refrigeration cycle.

The refrigerators have been increasingly enlarged and diversified in function in accordance with changes in dietary habits and the trend toward product sophistication. Refrigerators equipped with various structures and convenience devices that enhance user convenience and enable efficient use of the internal space have been introduced to the market.

The refrigerator may have a structure in which storage spaces are partitioned and arranged at upper and lower portions, and the upper and lower storage spaces are opened and closed by an upper door and a lower door, respectively. The upper and lower doors may each be rotatably mounted such that their upper and lower ends are supported by hinge apparatuses, and the vertically arranged storage spaces may be opened and closed through rotation of the upper and lower doors.

For example, Korean Patent Publication No. 10-2023-0060609 discloses a multi-joint hinge comprising a first link member configured to support an upper door, a second link member configured to support a lower door, a first link connection portion to which the first link member is coupled, a second link connection portion to which the second link member is coupled, and a partition wall configured to vertically separate the first link connection portion and the second link connection portion.

However, in such a structure, wear may occur as the first link member and the second link member are in continuous frictional contact with the partition wall made of a metallic material. Powder generated due to the wear may accumulate, thereby causing problems in the operational performance of the multi-joint hinge.

In addition, since the partition wall is disposed within a narrow space between the first link connection portion and the second link connection portion, there is a problem in that the assemblability is significantly deteriorated. It is also difficult to position the partition wall accurately within such a confined space, resulting in poor workability.

### SUMMARY

An embodiment of the present invention is directed to providing a center hinge and a refrigerator having the center hinge, which ensure smooth operational performance of an upper link module supporting an upper door and a lower link module supporting a lower door.

An embodiment of the present invention is directed to providing a center hinge and a refrigerator having the center hinge, which can reduce friction and wear between the upper link module supporting the upper door and the lower link module supporting the lower door.

An embodiment of the present invention is directed to providing a center hinge and a refrigerator having the center hinge, which allow easy assembly and thereby improve productivity.

In one embodiment, a center hinge includes a hinge bracket fixedly mounted to a cabinet of a refrigerator that is opened and closed by an upper door and a lower door; an upper link module disposed at an upper portion of the hinge bracket, the upper link module comprising a plurality of links and configured to connect the hinge bracket and the upper door to rotate the upper door; a lower link module disposed at a lower portion of the hinge bracket, the lower link module comprising a plurality of links and configured to connect the hinge bracket and the lower door to rotate the lower door; a spacer provided in the hinge bracket and on which the upper link module and the lower link module are mounted; and a first hinge shaft passing through the hinge bracket, the upper link module, the lower link module, and the spacer, and configured to enable rotation of the upper link module and the lower link module, wherein the upper link module and the lower link module are inserted in to the spacer in a state spaced apart from the hinge bracket.

At least a portion of the upper link module and the lower link module may be made of a metal material, and the spacer may be made of a non-metal material.

The hinge bracket includes a rear surface coupled to the cabinet; and a pair of side surfaces extending forward from upper and lower portions of the rear surface, and wherein the spacer may have an upper surface and a lower surface respectively contacting the pair of side surfaces.

The spacer includes an upper spacer on which the upper link module is mounted; and a lower spacer disposed below the upper spacer and on which the lower link module is mounted, wherein the upper spacer and the lower spacer are configured to rotate independently of each other.

The first hinge shaft sequentially may pass through the upper spacer and the lower spacer, and penetrates the upper link module and the lower link module that are inserted into the upper spacer and the lower spacer.

The upper link module may rotate together with the upper spacer in a coupled state, and the lower link module may rotate together with the lower spacer in a coupled state.

A first upper hole and a second upper hole, through which the first hinge shaft passes, may be formed on an upper surface and a lower surface of the upper spacer, respectively, and a first lower hole and a second lower hole, through which the first hinge shaft passes, are formed on an upper surface and a lower surface of the lower spacer, respectively, and wherein, in a state in which the upper spacer and the lower spacer may be coupled, the first upper hole, the second upper hole, the first lower hole, and the second lower hole are arranged on the same extension line.

A rotational coupling portion protruding along a periphery of the second upper hole may be formed on a lower surface of the upper spacer, and a coupling groove recessed along a periphery of the first lower hole is formed on an upper surface of the lower spacer, and wherein, when the upper spacer may be seated on the upper surface of the lower spacer, the rotational coupling portion may be inserted into the coupling groove to be rotatably coupled.

An upper connection portion opened to allow insertion of the upper link module is formed on a periphery of the upper spacer, and

A lower connection portion opened to allow insertion of the lower link module is formed on a periphery of the lower spacer, and

Wherein the upper connection portion and the lower connection portion are each formed in a size corresponding to an insertion portion of the upper link module and the lower link module, respectively.

The upper connection portion may be in communication with the first upper hole and the second upper hole, and the lower connection portion may be in communication with the first lower hole and the second lower hole.

The upper link module may be formed thicker than the lower link module, and a vertical height of the upper spacer may be formed greater than a vertical height of the lower spacer.

An upper surface of the spacer may be in contact with an upper surface of the hinge bracket, a lower surface of the spacer may be in contact with a lower surface of the hinge bracket, and a periphery of the spacer may be opened with a first connection portion into which the upper link module is inserted and a second connection portion into which the lower link module may be inserted.

A vertical height of the first connection portion may be formed greater than a vertical height of the second connection portion.

An intermediate portion may be formed between the first connection portion and the second connection portion to maintain a predetermined distance between the upper link module and the lower link module, and the first hinge shaft may penetrate the intermediate portion.

The spacer may have its upper and lower surfaces fixed to the hinge bracket, and the upper link module and the lower link module may be rotatable within the first connection portion and the second connection portion, respectively.

An opening width of the first connection portion and the second connection portion may be formed to correspond to rotational trajectories of the upper link module and the lower link module.

The center hinge may further include a second hinge shaft penetrating the hinge bracket, wherein the second hinge shaft may penetrate another side of the upper link module and the lower link module at a position spaced apart from the first hinge shaft and the spacer.

The center hinge may further include a sub spacer disposed between the upper link module and the lower link module, wherein the sub spacer may be penetrated by the second hinge shaft, and the sub spacer may be formed in a plate shape that contacts a lower surface of the upper link module and an upper surface of the lower link module.

The sub spacer may be formed in a disc shape, and a radius of the sub spacer may be smaller than a distance from the first hinge shaft to an inner surface of the hinge bracket and an outer surface of the spacer.

In another embodiment, a refrigerator includes a cabinet having an upper storage compartment and a lower storage compartment partitioned by a barrier; an upper door for opening and closing the upper storage compartment; an upper hinge connecting an upper end of the upper door to the cabinet; a lower door for opening and closing the lower storage compartment; a lower hinge connecting a lower end of the lower door to the cabinet; and a center hinge disposed between the upper door and the lower door, wherein the center hinge includes: a hinge bracket mounted to the barrier; an upper link module disposed above the hinge bracket and configured a plurality of links to connect the hinge bracket to the upper door and to rotate the upper door; a lower link module disposed below the hinge bracket and configured a plurality of links to connect the hinge bracket to the lower door and to rotate the lower door; a spacer provided in the hinge bracket and on which the upper link module and the lower link module are mounted; and a first hinge shaft penetrating the hinge bracket, the upper link module, the lower link module, and the spacer, and configured to rotate the upper link module and the lower link module, wherein the upper link module and the lower link module are inserted in to the spacer in a state spaced apart from the hinge bracket.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view showing an installation state of a refrigerator according to a first embodiment of the present invention.

FIG. 2 is a perspective view showing the refrigerator in which an upper door and a lower door are opened.

FIG. 3 is an enlarged view of a portion A in FIG. 2.

FIG. 4 is a perspective view showing a folded state of a center hinge according to the first embodiment of the present invention.

FIG. 5 is a perspective view showing a partially unfolded state of the center hinge.

FIG. 6 is an exploded perspective view of the center hinge.

FIG. 7 is an exploded perspective view of an upper link module of the center hinge.

FIG. 8 is an exploded perspective view of a spacer of the center hinge.

FIG. 9 is a cross-sectional view showing a state in which the spacer is assembled.

FIG. 10 is a cross-sectional view taken along line 10-10 of FIG. 5.

FIG. 11 is a cross-sectional view taken along line 11-11 of FIG. 5.

FIG. 12 is a series of views sequentially illustrating the operation of the center hinge.

FIG. 13 is a cross-sectional view taken along line 13-13 of FIG. 5.

FIG. 14 is a cross-sectional view taken along line 14-14 of FIG. 5.

FIG. 15 is a cross-sectional view taken along line 15-15 of FIG. 5.

FIG. 16 is a perspective view of a center hinge according to a second embodiment of the present invention.

FIG. 17 is an exploded perspective view of the center hinge shown in FIG. 16.

FIG. 18 is a perspective view showing a partially unfolded state of the center hinge according to the second embodiment.

FIG. 19 is a cross-sectional view taken along line 19-19 of FIG. 16.

FIG. 20 is a cross-sectional view taken along line 20-20 of FIG. 16.

FIG. 21 is a perspective view of a refrigerator according to a third embodiment of the present invention.

### DETAILED DESCRIPTION OF THE EMBODIMENTS

Hereinafter, specific embodiments of the present invention will be described in detail with reference to the drawings. However, the present invention is not limited to the embodiments presented for illustrating the spirit of the invention, and various other embodiments falling within the scope of the inventive concept may be easily proposed through addition, modification, or deletion of other components without being retrogressive inventions.

In the multiple embodiments of the present invention, components that are identical may be indicated by the same reference numerals in order to avoid redundant description.

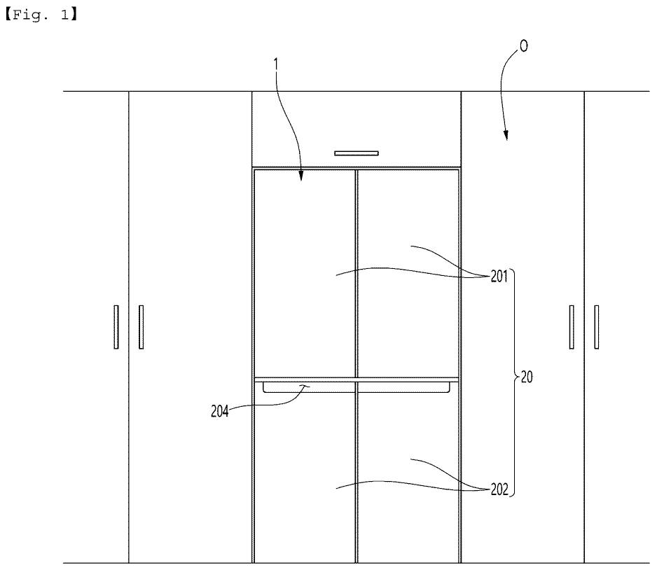

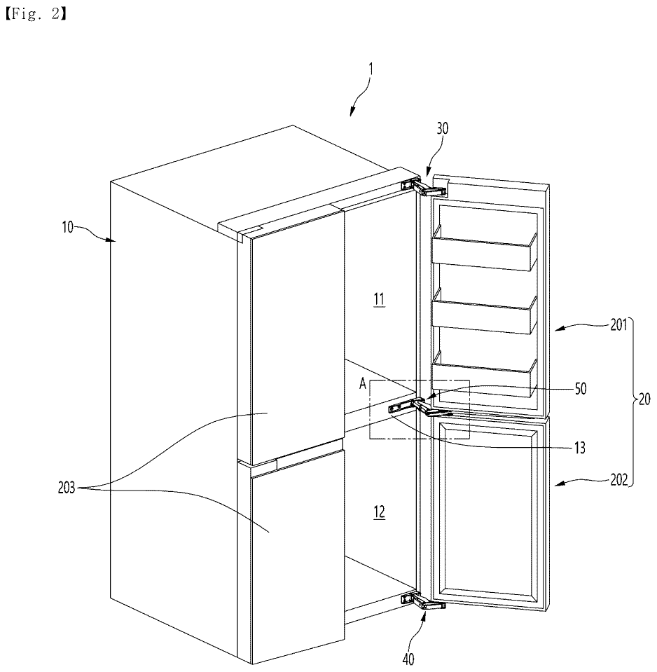

Before describing embodiments of the present invention, directions will be defined. In the embodiment of the present invention, as shown in FIGS. 1 and 2, the direction in which the front surface of the door faces is defined as a front direction, the direction toward the inside of the refrigerator relative to the front surface of the door is defined as a rear direction, the direction toward a floor surface on which the refrigerator is installed is defined as a lower direction, and the direction away from the floor surface is defined as an upper direction. Of course, for convenience of description, when it is necessary to redefine directions, the directions may be redefined based on the drawings.

Furthermore, when referring to a direction not previously defined, the direction may be redefined and described based on each drawing.

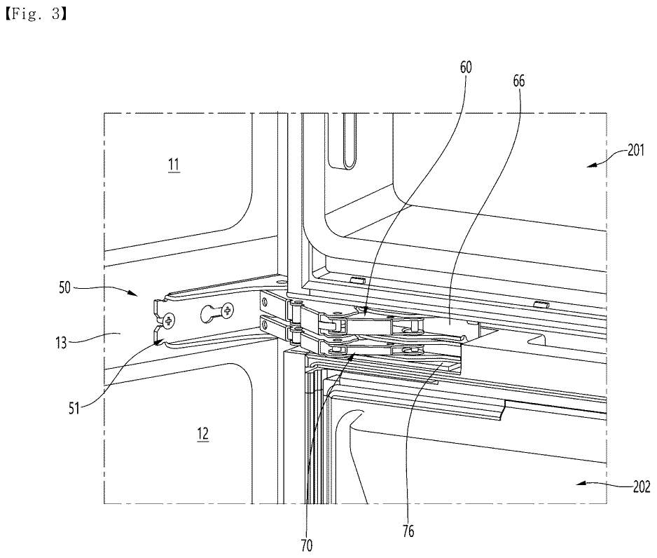

FIG. 1 is a perspective view showing an installation state of a refrigerator according to a first embodiment of the present invention, and FIG. 2 is a perspective view showing the refrigerator in which an upper door and a lower door are opened, and FIG. 3 is an enlarged view of a portion A in FIG. 2.

As shown in the drawings, a refrigerator 1 according to an embodiment of the present invention may have an overall appearance formed by a cabinet 10 that defines a storage space opened at its front side and doors 20 and 30 that open and close the storage space.

The refrigerator 1 may be installed so as to harmonize with furniture or a wall O in an indoor space. For example, as shown in FIG. 1, the refrigerator 1 may be installed in an indoor space such as a kitchen, and may be disposed adjacent to the furniture or the wall O to achieve a harmonious appearance. That is, a space corresponding to the size of the refrigerator 1 may be provided in the furniture or wall O, and the refrigerator 1 may be accommodated therein or disposed in a built-in type. Of course, in addition to the furniture or wall O, a plurality of refrigerators may be sequentially arranged, or other home appliances may be continuously disposed adjacent to the refrigerator 1.

In such an installation structure of the refrigerator 1, the front surface of the refrigerator 1, that is, the front surface of the door 20, may be positioned very close to the furniture or wall O, and may be located on the same or a substantially flush plane to provide a sense of unity. If necessary, the front surface of the door 20 may be made of a material having the same or similar texture or appearance as that of the furniture or wall O, thereby enhancing the integrated visual harmony between the refrigerator 1 and the adjacent furniture or wall O.

In more detail, the structure of the refrigerator 1 according to the embodiment of the present invention will be described. The cabinet 10 may form storage spaces partitioned vertically. For example, the cabinet 10 may be partitioned into upper and lower sections by a barrier 13, thereby defining an upper storage space 11 above the barrier 13 and a lower storage space 12 below the barrier 13. In one example, the upper storage space 11 may serve as a refrigerating compartment, and the lower storage space 12 may serve as a freezing compartment.

The door 20 may include an upper door 201 and a lower door 202 for opening and closing the upper storage space 11 and the lower storage space 12, respectively. The upper door 201 and the lower door 202 may each be provided as a pair on both left and right sides, and may be independently and rotatably mounted to the cabinet 10.

Specifically, an upper end and a lower end of the upper door 201 are connected to the cabinet 10 by an upper hinge 30 and a center hinge 50, respectively, so that the upper door 201 can open and close the upper storage space 11 through rotation. Likewise, an upper end and a lower end of the lower door 202 are connected to the cabinet 10 by the center hinge 50 and a lower hinge 40, respectively, so that the lower door 202 can open and close the lower storage space 12 through rotation.

Meanwhile, the upper door 201 may be provided with a dispenser that allows a user to dispense water or ice from the outside of the upper door 201 when the upper door 201 is in a closed state. In addition, a storage member such as a door basket for storing food items may be further provided on a rear surface of the upper door 201. A panel or plate 203 for forming an exterior appearance of the upper door 201 may be disposed on a front surface of the door 20. The panel or plate 203 may be made of various materials such as tempered glass, metal, or tile, for example.

The upper door 201 may be formed to have a relatively larger size than the lower door 202. Due to the plurality of components disposed in the upper door 201, the upper door 201 may have a greater weight than the lower door 202.

A handle 204 into which a user can insert a hand may be formed between a lower end of the upper door 201 and an upper end of the lower door 202. The handle 204 may be recessed so that the user can insert a hand between the upper door 201 and the lower door 202, and grip a lower portion of the upper door 201 or an upper portion of the lower door 202 to open or close the door 20.

Meanwhile, the upper hinge 30, the center hinge 50, and the lower hinge 40 may be rotated along the same trajectory, so that the upper door 201 and the lower door 202 can be smoothly rotated during opening and closing without interference with adjacent furniture or a wall O.

In detail, the upper hinge 30, the lower hinge 40, and the center hinge 50 may have a multi-link structure composed of a combination of multiple links. Accordingly, when the door 20 is opened or closed, a side edge of the door 20 may move toward the center direction of the cabinet 10, and the door 20 may have a rotational trajectory in which it rotates while moving forward. Therefore, the side edge of the door 20 does not collide with the wall or furniture O positioned on the side where the refrigerator 1 is installed, and a sufficient opening angle can be ensured.

The upper hinge 30 and the lower hinge 40 may have the same or similar structure. Although the center hinge 50 has a different structure from the upper hinge 30 and the lower hinge 40, it may be configured to have the same rotational trajectory, so that the upper door 201 and the lower door 202 can rotate naturally along the same trajectory.

The center hinge 50 rotatably supports the upper door 201 and the lower door 202. Accordingly, the center hinge 50 may be disposed between the upper door 201 and the lower door 202.

In detail, the center hinge 50 may be positioned in a space between a lower surface of the upper door 201 and an upper surface of the lower door 202, and may be mounted on a front portion of the cabinet 10.

The center hinge 50 may be mounted on a front surface of the barrier 13, and may be connected respectively to the lower surface of the upper door 201 and the upper surface of the lower door 202, so that the upper door 201 and the lower door 202 can rotate independently of each other.

That is, the center hinge 50 may include a hinge bracket 51 mounted on the barrier 13, and an upper link module 60 and a lower link module 70 composed of multiple links pivotally coupled to the hinge bracket 51. The upper link module 60 may be coupled to a lower surface of the upper door 201, and the lower link module 70 may be coupled to an upper surface of the lower door 202.

The upper link module 60 and the lower link module 70 may be vertically arranged within an inner region of the hinge bracket 51. The upper link module 60 and the lower link module 70 may be formed at least partially of a metallic material, thereby stably supporting the heavy door 20 and minimizing deformation.

The upper link module 60 is a structure that supports the upper door 201 from below, and thus has a relatively higher possibility of sagging or deforming due to the load of the upper door 201. Accordingly, in order to prevent the upper link module 60 from sagging downward or being deformed under the load of the upper door 201, the upper link module 60 may be formed thicker than the lower link module 70.

Hereinafter, the center hinge 50 will be described in more detail with reference to the drawings.

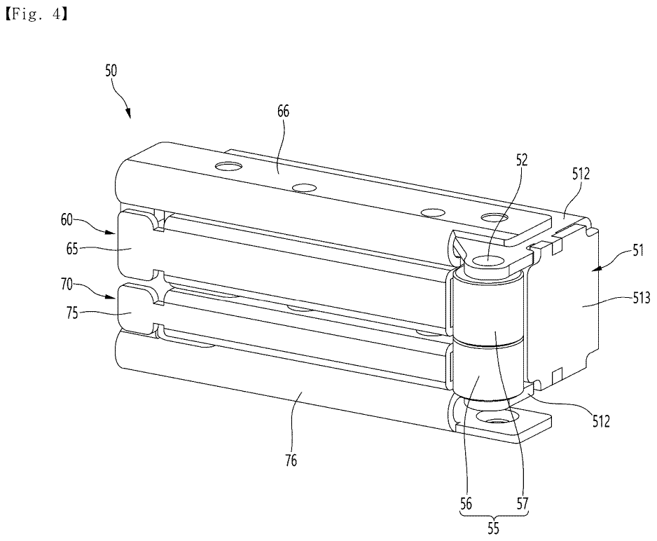

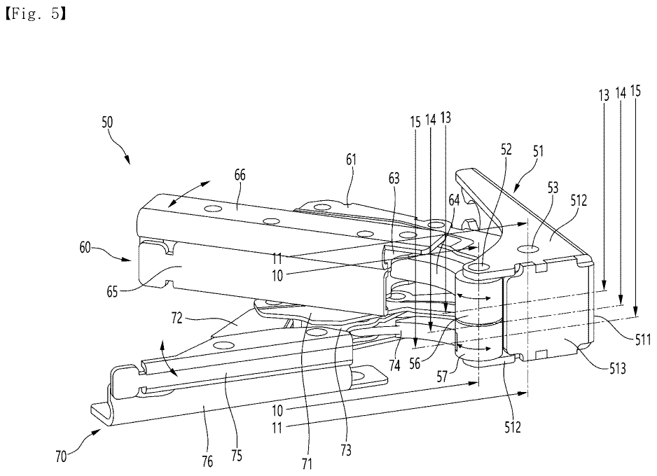

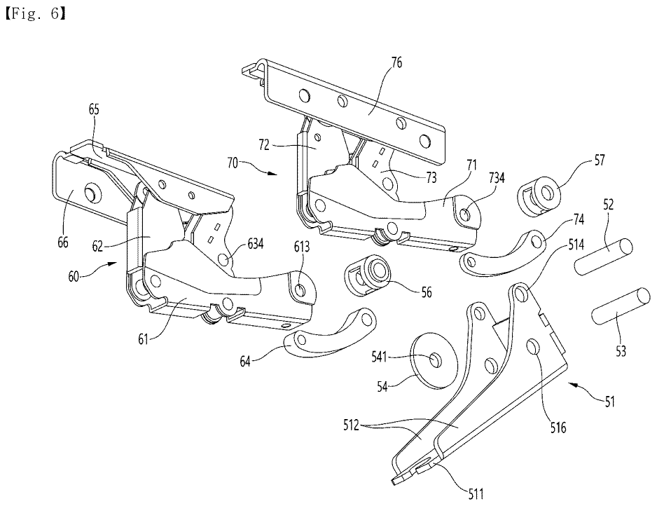

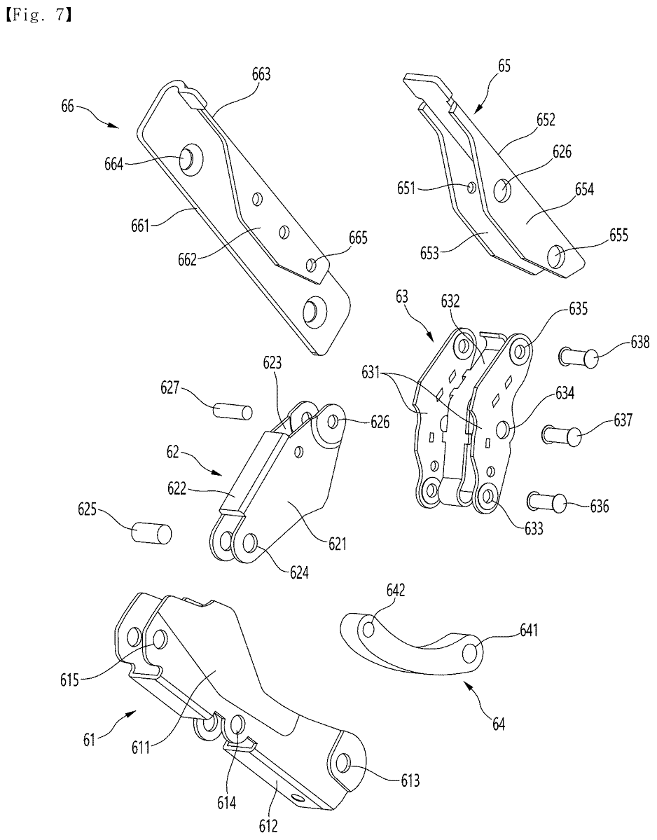

FIG. 4 is a perspective view showing a folded state of a center hinge according to the first embodiment of the present invention, and FIG. 5 is a perspective view showing a partially unfolded state of the center hinge, and FIG. 6 is an exploded perspective view of the center hinge, and FIG. 7 is an exploded perspective view of an upper link module of the center hinge.

As shown in the drawings, the center hinge 50 may include a hinge bracket 51. The hinge bracket 51 may include a rear surface 511 coupled to the cabinet 10 by screws, a pair of side surfaces 512 extending forward from upper and lower ends of the rear surface 511, and a shielding portion 513 connecting end portions of the rear surface 511 and the side surfaces 512. The hinge bracket 51 may be formed of a metallic material.

An internal space defined by the rear surface 511, the side surfaces 512, and the shielding portion 513 may rotatably accommodate the upper link module 60 and the lower link module 70. The upper link module 60 and the lower link module 70 may each be composed of a combination of multiple links. When the door 20 is in a closed state, as shown in FIG. 4, the upper link module 60 and the lower link module 70 may be folded into a compact state. When the door 20 is opened, as shown in FIG. 5, the upper link module 60 and the lower link module 70 may unfold and rotate.

An upper door bracket 67 coupled to a lower end of the upper door 201 may be provided at an end portion of the upper link module 60. A lower door bracket 77 coupled to an upper end of the lower door 202 may be provided at an end portion of the lower link module 70.

The upper link module 60 and the lower link module 70 may have the same configuration so as to have the same rotational trajectory. However, since the upper link module 60 supports the relatively heavy upper door 201 from below, it may have a thicker structure than the lower link module 70. Hereinafter, the structure of the upper link module 60 will be described in detail, and the detailed description of the lower link module 70 will be omitted.

The upper link module 60 may include an upper main link 61, a first upper sub link 62, a second upper sub link 63, and an upper door bracket 65. The first upper sub link 62 and the second upper sub link 63 may be rotatably connected between the upper main link 61 and the upper door bracket 65. The upper link module 60 may further include an upper connecting link 64 that rotatably connects the second upper sub link 63 to the hinge bracket 51.

In more detail, the upper main link 61 may be formed of a plate-shaped metallic material and may be bent multiple times so that at least portions of the upper connecting link 64, the first upper sub link 62, and the second upper sub link 63 are accommodated therein. For example, the upper main link 61 may include an upper surface 611, a lower surface 613, and a connecting surface 612 connecting the upper surface 611 and the lower surface 613.

At one end of the upper surface 611 and the lower surface 613, an upper main hole 616 through which a first hinge shaft 52 passes may be formed. Shaft holes 614 and 615 to which ends of the first upper sub link 62 and the second upper sub link 63 are rotatably coupled by shafts 626 and 636, respectively, may be formed on the upper surface 611 and the lower surface 613 of the upper main link 61. The shafts 626 and 636 may penetrate through the shaft holes 614 and 615 so that the first upper sub link 62 and the second upper sub link 63 can be rotatably connected.

The first upper sub link 62 may be pivotally connected to an end of the upper main link 61 by a shaft 625. The first upper sub link 62 may be formed of a metal plate and may be bent multiple times. For example, the first upper sub link 62 may include a sub upper surface 621, a sub lower surface 623, and a sub connecting surface 622 connecting the sub upper surface 621 and the sub lower surface 623. When the upper link module 60 is completely folded, the sub upper surface 621 and the sub lower surface 623 may be inserted into the second upper sub link 63.

The first upper sub link 62 may be formed with shaft holes 624 and 626 at both ends of the sub upper surface 621 and the sub lower surface 623, respectively, and rotation shafts 625 and 627 may be coupled to the shaft holes 624 and 626, respectively. Accordingly, one end of the first upper sub link 62 may be rotatably connected to the upper main link 61, and the other end of the first upper sub link 62 may be rotatably connected to the upper door bracket 65.

The second upper sub link 63 may be formed as a plate-shaped member made of a metallic material. For example, the second upper sub link 63 may include side plates 631 forming upper and lower surfaces, and a connecting plate 632 connecting the pair of side plates 631 to each other.

The connecting plate 632 may extend along an intermediate portion between the pair of side plates 631. Accordingly, based on the connecting plate 632, the first upper sub link 62 may be inserted into one side of an inner space of the second upper sub link 63, and the upper connecting link 64 may be inserted into the other side of the inner space of the second upper sub link 63.

Both ends of the second upper sub link 63, that is, both ends of the side plates 631, may be formed with shaft holes 633 and 635. Rotation shafts 636 and 638 may be coupled to the shaft holes 633 and 635, respectively. Accordingly, one end of the second upper sub link 63 may be rotatably connected to the upper main link 61, and the other end of the second upper sub link 63 may be rotatably connected to the upper door bracket 67.

A shaft hole 634 through which a rotation shaft 637 coupled to the upper connecting link 64 passes may further be formed between the side plates 631. Accordingly, the upper connecting link 64 may be rotatably connected to the second upper sub link 63.

The upper connecting link 64 may rotatably connect the second upper sub link 63 and the hinge bracket 51. Shaft hole 642 and connection hole 641 may be formed at both ends of the upper connecting link 64.

The rotation shaft 636 may be coupled to the shaft hole 642, so that one end of the upper connecting link 64 and the second upper sub link 63 are rotatably connected. The first hinge shaft 52 may be coupled to the connection hole 641 so that the upper connecting link 64 is connected to the hinge bracket 51. At this time, the first hinge shaft 52 may penetrate through an upper spacer 56 provided in the hinge bracket 51. The upper spacer 56 may be combined with a lower spacer 57, described below, so that the upper connecting link 64 and a lower connecting link 74 maintain a spacing from each other within the hinge bracket 51.

The ends of the first upper sub link 62 and the second upper sub link 63 may be connected to the upper door bracket 65, respectively. The upper door bracket 65 may connect the upper link module 60 and the upper door 201.

The upper door bracket 67 may include a door part 66 coupled to a lower surface of the upper door 201, and a hinge part 65 connected to the first upper sub link 62 and the second upper sub link 63 by shafts 627 and 638. The door part 66 and the hinge part 65 may be bent multiple times so as to stably support the high load of the upper door 201 without deformation.

For example, the door part 66 may include a first door surface 661 and a second door surface 662 disposed side by side, and a third door surface 663 connecting the first door surface 661 and the second door surface 662. A screw hole 664, into which a screw for coupling with the upper door 201 is fastened, may be formed in the first door surface 661. A screw hole 665, into which a screw for coupling with the hinge part 65 is fastened, may be formed in the second door surface 662.

The hinge part 65 may include a first hinge surface 651 and a second hinge surface 652 disposed side by side, and a third hinge surface 653 connecting the first hinge surface 651 and the second hinge surface 652. A screw hole 654 into which a screw for coupling with the door part 66 is fastened may be formed in the first hinge surface 651. Shaft holes 655 and 656 through which shafts 627 and 638 coupled to the first upper sub link 62 and the second upper sub link 63 pass may be formed in the second hinge surface 652.

The door part 66 and the hinge part 65 may be coupled to each other by screws or rivets. Therefore, by coupling the bent door part 66 and the hinge part 65 together, the upper door bracket 67 may have a more rigid structure and may not be deformed even under the high load of the upper door 201.

Meanwhile, the lower link module 70 may include a lower main link 71, a first lower sub link 72, a second lower sub link 73, and a lower door bracket 77. The first lower sub link 72 and the second lower sub link 73 may be rotatably connected between the lower main link 71 and the lower door bracket 77. The lower link module 70 may further include a lower connecting link 74 that rotatably connects the second lower sub link 73 to the hinge bracket 51.

The upper link module 60 and the lower link module 70 may be rotatably connected to the hinge bracket 51 by the first hinge shaft 52 and the second hinge shaft 53. Specifically, the first hinge shaft 52 may be connected so as to penetrate through a pair of side surfaces 512 of the hinge bracket 51, and may pass through the upper spacer 56 and the lower spacer 57 disposed between the pair of side surfaces 512, as well as one ends of the upper link module 60 and the lower link module 70. The second hinge shaft 53 may be connected so as to penetrate through the side surfaces 512 of the hinge bracket 51, and may pass through the other ends of the upper link module 60 and the lower link module 70.

In detail, the first hinge shaft 52 may simultaneously penetrate through the upper spacer 56, the lower spacer 57, the upper connecting link 64, and the lower connecting link 74 provided in the hinge bracket 51, and may be coupled to the hinge bracket 51. The second hinge shaft 53 may penetrate through the upper main link 61 and the lower main link 71 and may be coupled to the hinge bracket 51. For this purpose, the side surfaces 512 of the hinge bracket 51 may be formed with a first shaft hole 514 into which the first hinge shaft 52 is inserted, and a second shaft hole 516 into which the second hinge shaft 53 is inserted.

In addition, a sub spacer 54 may be provided inside the hinge bracket 51. The sub spacer 54 may be disposed between the upper link module 60 and the lower link module 70 to maintain a spacing therebetween.

The sub spacer 54 may be formed in a plate shape having a thickness corresponding to a spacing between a lower surface of the upper main link 61 and an upper surface of the lower main link 71. For example, the sub spacer 54 may be formed of a metal material having high strength. The sub spacer 54 may have a circular plate shape and therefore may be referred to as a disc spacer. The upper spacer 56 and the lower spacer 57 may be referred to as main spacers to be distinguished from the sub spacer 54.

The sub spacer 54 may have a circular plate shape and may have a radius R such that it can contact the lower surface of the upper main link 61 and the upper surface of the lower main link 71.

A sub hole 541 may be formed at the center of the sub spacer 54. The second hinge shaft 53, which penetrates through the pair of side surfaces 512, may pass through the sub hole 541. Accordingly, the sub spacer 54 may be rotatable about the second hinge shaft 53. The second hinge shaft 53 may be rotatably connected to the second shaft hole 516 formed in the side surfaces 512.

Hereinafter, with reference to the drawings, a detailed description will be given of the spacers 55.

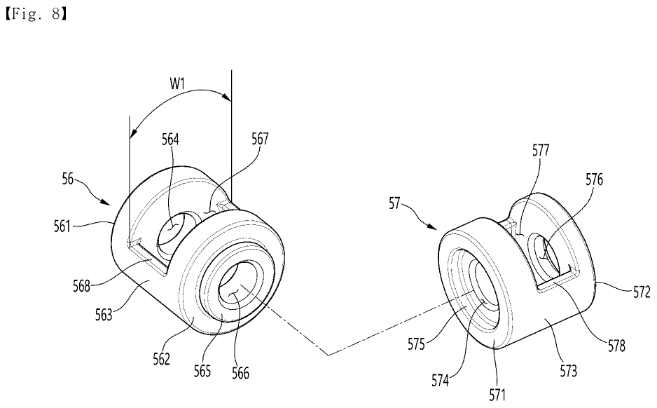

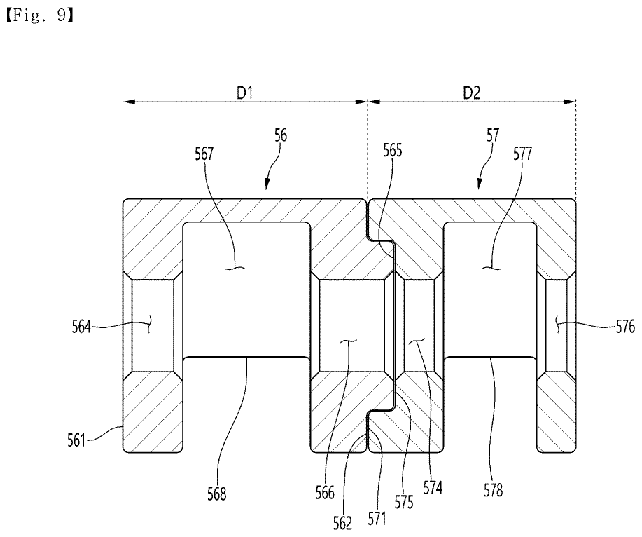

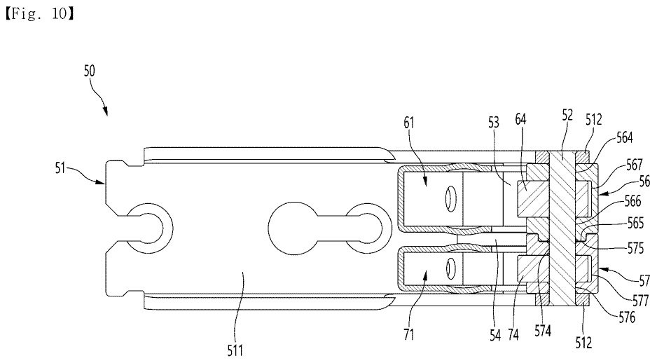

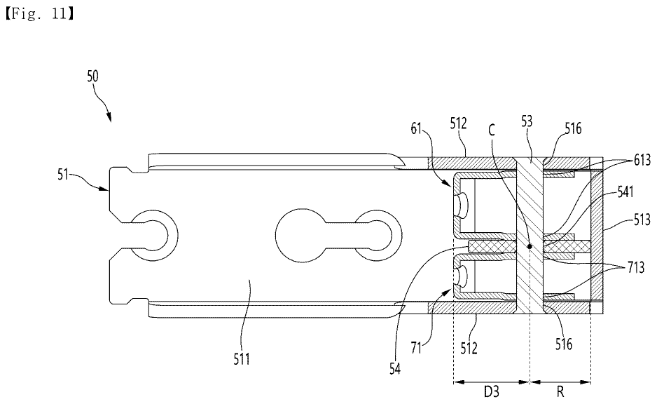

FIG. 8 is an exploded perspective view of a spacer of the center hinge, and FIG. 9 is a cross-sectional view showing a state in which the spacer is assembled, and FIG. 10 is a cross-sectional view taken along line 10-10 of FIG. 5, and FIG. 11 is a cross-sectional view taken along line 11-11 of FIG. 5.

As illustrated, a spacer 55 may be provided in the hinge bracket 51. The spacer 55 may be disposed between the pair of side surfaces 512 of the hinge bracket 51. An upper surface 561 of the spacer 55 may contact the side surface 512 positioned above, and a lower surface 572 of the spacer 55 may contact the side surface 512 positioned below. The vertical height of the spacer 55 may correspond to the distance between the pair of side surfaces 512.

The spacer 55 may be generally formed in a cylindrical shape and may be configured to rotate together with the upper link module 60 or the lower link module 70 inside the hinge bracket 51. The spacer 55 may be made of a material having excellent wear resistance. The spacer 55 may be formed of a non-metallic material having excellent lubricating properties. For example, the spacer 55 may be made of an engineering plastic material. The spacer 55 may be penetrated by the first hinge shaft 52 coupled to the hinge bracket 51. The ends of the upper connecting link 64 and the lower connecting link 74 may be rotatably connected to the spacer 55.

Specifically, the spacer 55 may include an upper spacer 56 and a lower spacer 57. The upper spacer 56 may be connected to the upper link module 60 by the first hinge shaft 52. The upper spacer 56 and the lower spacer 57 may be made of the same material and may be configured to be stacked in the vertical direction. The upper spacer 56 and the lower spacer 57 may have the same outer diameter, and thus may appear as a single cylindrical body in the stacked state. The upper spacer 56 and the lower spacer 57 may be configured to rotate relative to each other. Of course, if necessary, the upper spacer 56 may be made of a material having higher strength than that of the lower spacer 57 so as to withstand higher loads.

The upper spacer 56 may be formed in a cylindrical shape and may include an upper surface 561, a lower surface 562, and a circumferential surface 563 between the upper surface 561 and the lower surface 562. The upper surface 561 may be formed in a planar shape and may contact the side surface 512 forming the upper surface of the hinge bracket 51. A first upper hole 564, into which the first hinge shaft 52 is inserted, may be formed at the center of the upper surface 561.

The lower surface 562 of the upper spacer may be formed in a planar shape contacting the upper surface 571 of the lower spacer 57. A second upper hole 566, into which the first hinge shaft 52 is inserted, may be formed at the center of the lower surface 562. A rotational coupling portion 565 may be formed to protrude downward from the lower surface 562. The rotational coupling portion 565 may be inserted into and coupled with the lower spacer 57. The rotational coupling portion 565 may protrude downward along the periphery of the second upper hole 566 and may be projected with a step from the lower surface 562.

A hollow portion 567 may be formed inside the circumferential surface 563, and an upper connecting part 568, into which the upper connecting link 64 is inserted, may be opened on the circumferential surface 563. The upper connecting part 568 may be opened along the circumference of the circumferential surface 563 so that the hollow portion 567 is exposed through the upper connecting part 568.

The upper connecting part 568 may have a vertical height greater than the thickness of the upper connecting link 64 and a lateral width greater than the width of the upper connecting link 64. That is, the width W1 of the upper connecting part 568 may be formed large enough for the upper connecting link 64 to be inserted. The width W1 of the upper connecting part 568 may be smaller than one half of the circumferential length of the circumferential surface 563.

Meanwhile, the first upper hole 564 and the second upper hole 566 may be arranged on the same extension line and may communicate with the hollow portion 567. Accordingly, the first hinge shaft 52 may sequentially penetrate through the first upper hole 564, the hollow portion 567, and the second upper hole 566.

The lower spacer 57 may be formed in a cylindrical shape and may include an upper surface 571, a lower surface 572, and a circumferential surface 573 between the upper surface 571 and the lower surface 572. The upper surface 571 may be formed in a planar shape contacting the lower surface 562 of the upper spacer 56. A coupling groove 575, into which the rotational coupling portion 565 is inserted, may be recessed at the center of the upper surface 571. The coupling groove 575 may be formed to have a size and shape corresponding to the rotational coupling portion 565 and may be formed with a step from the upper surface 571.

In a state where the rotational coupling portion 565 is inserted into the coupling groove 575, the lower surface 562 of the upper spacer 56 and the upper surface 571 of the lower spacer 57 may be in contact with and support each other. The upper spacer 56 and the lower spacer 57 may be rotatable relative to each other in the state where the rotational coupling portion 565 is inserted into the coupling groove 575.

A first lower hole 574, into which the first hinge shaft 52 is inserted, may be formed at the center of the upper surface 571. The first lower hole 574 may be formed inside the coupling groove 575.

The lower surface 572 may be formed in a planar shape and may contact the side surface 512 forming the lower surface of the hinge bracket 51. A second lower hole 576, into which the first hinge shaft 52 is inserted, may be formed at the center of the lower surface 572.

A hollow portion 577 may be formed inside the circumferential surface 573 of the lower spacer 57, and a lower connecting part 578, into which the lower connecting link 74 is inserted, may be opened on the circumferential surface 573. The lower connecting part 578 may be opened along the circumference of the circumferential surface 573 so that the hollow portion 577 is exposed through the lower connecting part 578.

The lower connecting part 578 may have a vertical height greater than the thickness of the lower connecting link 74 and a lateral width greater than the width of the lower connecting link 74. The width of the lower connecting part 578 may be the same as the width W1 of the upper connecting part 568.

Meanwhile, the first lower hole 574 and the second lower hole 576 may be arranged on the same extension line and may communicate with the hollow portion 577. Accordingly, the first hinge shaft 52 may sequentially penetrate through the first lower hole 574, the hollow portion 577, and the second lower hole 576.

In a state where the upper spacer 56 and the lower spacer 57 are connected to each other, the first upper hole 564, the second upper hole 566, the first lower hole 574, and the second lower hole 576 may all be positioned on the same extension line. Accordingly, the upper spacer 56, the upper connecting link 64, the lower spacer 57, and the lower connecting link 74 may sequentially be penetrated by the first hinge shaft 52, and both ends of the first hinge shaft 52 may be connected to the hinge bracket 51.

In addition, the upper spacer 56 and the lower spacer 57 may be arranged so as to contact both side surfaces 512 of the hinge bracket 51. Therefore, the upper spacer 56 may maintain a stable fixed state inside the hinge bracket 51 and may be fixed within the hinge bracket 51 by the first hinge shaft 52 penetrating therethrough. As a result, stable operation of the upper link module 60 and the lower link module 70 may be ensured when the upper door 201 or the lower door 202 is opened.

In particular, the connected upper spacer 56 and lower spacer 57 may fill the space between the pair of side surfaces 512 and may simultaneously be fixed in a rotatable state within the hinge bracket 51 by the first hinge shaft 52.

Further, the upper connecting link 64 and the lower connecting link 74 may each be penetrated by the first hinge shaft 52 inside the upper spacer 56 and the lower spacer 57, respectively. Accordingly, stable and independent rotation of the upper link module 60 and the lower link module 70 may be achieved. In this case, the upper connecting link 64 and the lower connecting link 74 may be coupled to the upper spacer 56 and the lower spacer 57 so that vertical movement is restricted, thereby maintaining a constant spacing without vertical displacement even during opening and closing of the door 20.

That is, the first hinge shaft 52 may penetrate through the first shaft hole 514, the first upper hole 564, the second upper hole 566, the first lower hole 574, the second lower hole 576, and the connecting holes 541 of the upper connecting link 64 and the lower connecting link 74. Accordingly, the hinge bracket 51, the upper spacer 56, the lower spacer 57, the upper link module 60, and the lower link module 70 may be assembled in a rotatable state by a single first hinge shaft 52.

Even when the upper link module 60 and the lower link module 70 operate due to the opening and closing of the upper door 201 and the lower door 202, causing the upper spacer 56 and the lower spacer 57 to repeatedly rotate, the upper spacer 56 and the lower spacer 57 are not worn out.

The vertical height D1 of the upper spacer 56 may be greater than the vertical height D2 of the lower spacer 57. Since the upper link module 60 supports the upper door 201, it may have a relatively thicker structure, and correspondingly, the upper spacer 56 may also have a greater vertical height D1, thereby withstanding a higher load compared to the lower spacer 57.

Meanwhile, the upper second hinge shaft 53 may be mounted to the hinge bracket 51 so as to penetrate through the second shaft hole 516. The second hinge shaft 53 may penetrate through the upper main link 61 and the lower main link 71 inside the hinge bracket 51. In this case, the second hinge shaft 53 may pass through the upper main hole 613 of the upper main link 61 and the lower main hole 713 of the lower main link 71.

The second hinge shaft 53 may penetrate through the sub spacer 54. The sub spacer 54 may be disposed between the upper main link 61 and the lower main link 71. The lower surface of the upper main link 61 may contact the upper surface of the sub spacer 54, and the upper surface of the lower main link 71 may contact the lower surface of the sub spacer 54. The sub spacer 54 may be formed in a plate shape and may be made of a material having high strength and excellent wear resistance. For example, the sub spacer 54 may be formed of a metal material or an engineering plastic material.

The sub spacer 54 serves to prevent sagging of the upper link module 60 and may support the upper main link 61 from below. The sub spacer 54 may be formed to have a radius R that is set to sufficiently support the upper main link 61.

For example, the radius R may be slightly smaller than the distance from the center of the second hinge shaft 53 to the shielding portion 513. The radius R may also be slightly smaller than the distance from the center of the second hinge shaft 53 to the outer surface of the spacer 55. In addition, the radius R may be shorter than the distance D3 from the center of the second hinge shaft 53 to one side end of the upper main link 61. Accordingly, the sub spacer 54 can effectively support the upper link module 60 without protruding between the upper link module 60 and the lower link module 70.

Hereinafter, the operating state of the center hinge 50 having the above structure will be described in more detail with reference to the drawings.

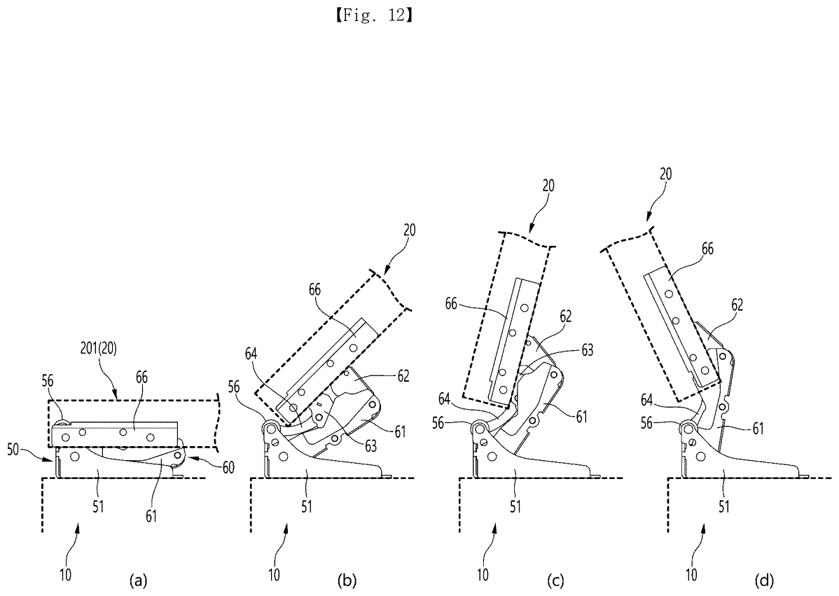

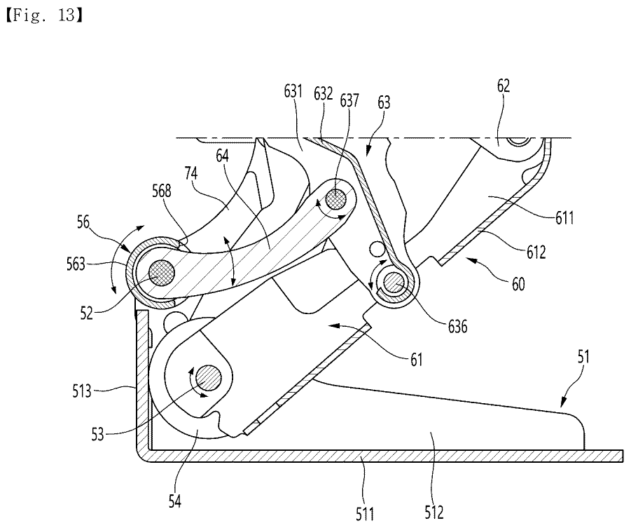

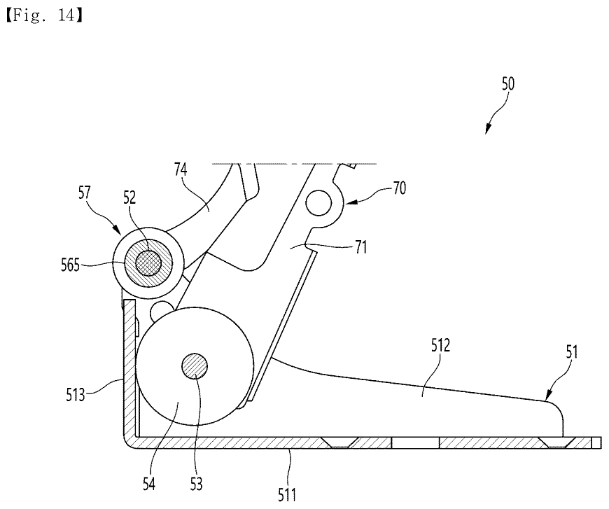

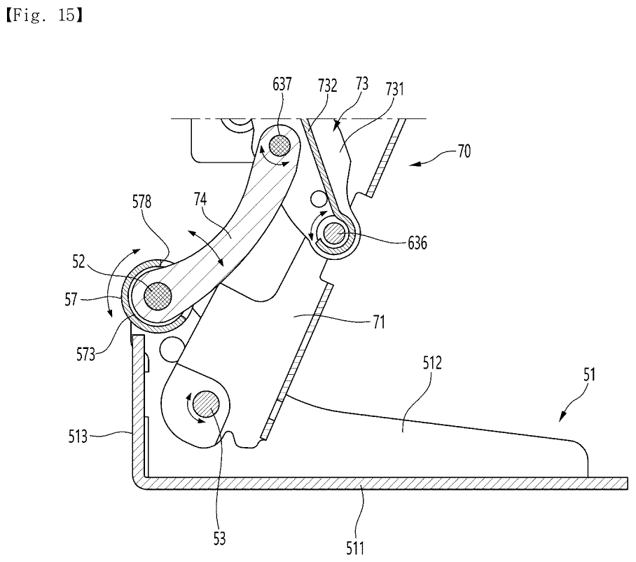

FIG. 12 is a series of views sequentially illustrating the operation of the center hinge, and FIG. 13 is a cross-sectional view taken along line 13-13 of FIG. 5, and FIG. 14 is a cross-sectional view taken along line 14-14 of FIG. 5, and FIG. 15 is a cross-sectional view taken along line 15-15 of FIG. 5.

As shown in FIG. 12(a), when the upper door 201 is in a closed state, the center hinge 50 may be in a fully folded state.

When the upper door 201 is operated to open from this state, as shown in FIG. 12(b), the upper link module 60 rotates, and simultaneously, the upper main link 61, the first upper sub link 62, the second upper sub link 63, and the upper connecting link 64, which constitute the upper link module 60, rotate together, thereby initiating the opening of the upper door 201.

For example, FIG. 12(b) illustrates a state in which the upper door 201 is opened at an angle of 45°with respect to the front surface of the cabinet 10. During the opening process, the upper door 201 is rotated by the upper link module 60 in such a manner that the edge of the upper door 201 protrudes outwardly beyond the cabinet 10, thereby preventing contact with the wall O.

When the upper door 201 is further opened, as shown in FIG. 12(c), the upper link module 60 may further rotate and unfold. At this time, the upper main link 61, the first upper sub link 62, the second upper sub link 63, and the upper connecting link 64, which constitute the upper link module 60, further rotate to enable the upper door 201 to open wider. For example, FIG. 12(c) illustrates a state in which the upper door 201 is opened at an angle of 75° with respect to the front surface of the cabinet 10. During this opening process, the edge of the upper door 201 protrudes outwardly beyond the cabinet 10, thereby preventing the upper door 201 from colliding with the wall O.

During the process of opening the upper door 201, as shown in FIG. 13, the upper connecting link 64 may rotate about the first hinge shaft 52 while remaining connected to the upper spacer 56. At this time, the upper spacer 56 may rotate independently of the lower spacer 57. Accordingly, the upper link module 60 may rotate without direct contact with the hinge bracket 51 or the lower link module 70, thereby preventing wear caused by contact.

As shown in FIGS. 13 and 14, when the upper door 201 is opened, the sub spacer 54 may support the upper main link 61 from below. During the rotation of the upper link module 60, the sub spacer 54 maintains the gap between the upper main link 61 and the lower main link 71, thereby preventing the upper main link 61 from sagging downward and preventing interference between the upper link module 60 and the lower link module 70.

In addition, during the process of opening the lower door 202, as shown in FIG. 15, the lower connecting link 74 remains connected to the lower spacer 57 and may rotate about the first hinge shaft 52. At this time, the lower spacer 57 may rotate independently of the upper spacer 56. Accordingly, the lower link module 70 may rotate without direct contact with the hinge bracket 51 or the upper link module 60, thereby preventing wear caused by contact.

Furthermore, when the upper door 201 is in a fully opened state, the upper link module 60 may be fully unfolded, as shown in FIG. 12(d). For example, the upper door 201 may be opened at an angle of approximately 115°with respect to the front surface of the cabinet 10. During the complete opening process, the upper door 201 may be fully opened without interference with the adjacent wall O.

The center hinge 50 may operate in the reverse order of the above-described process when the upper door 201 and the lower door 202 are closed.

Meanwhile, it will be understood that the present invention is not limited to the foregoing embodiments, and various other embodiments may also be possible. Hereinafter, other embodiments of the present invention will be described with reference to the drawings. Among the components of other embodiments of the present invention, those that are identical to the components of the foregoing embodiments may have their detailed descriptions and illustrations omitted, and the same reference numerals may be used to denote the same components. That is, only structural features that differ from the foregoing embodiments will be described below, and components not specifically described may be identical to those of the foregoing embodiments. Therefore, configurations that are not illustrated or not described in detail may be referred to from the drawings of the foregoing embodiments.

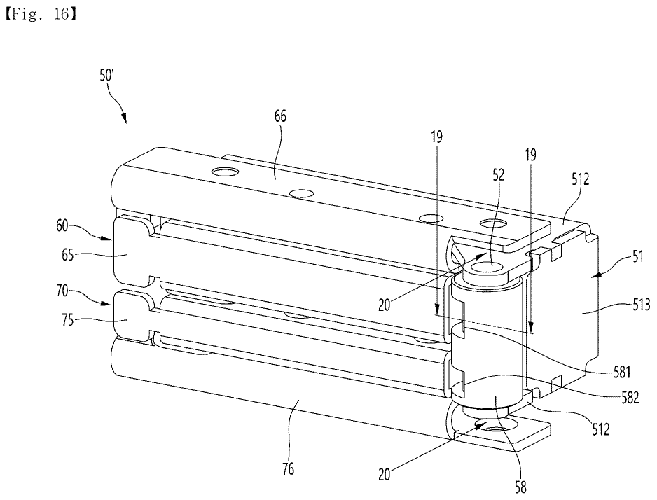

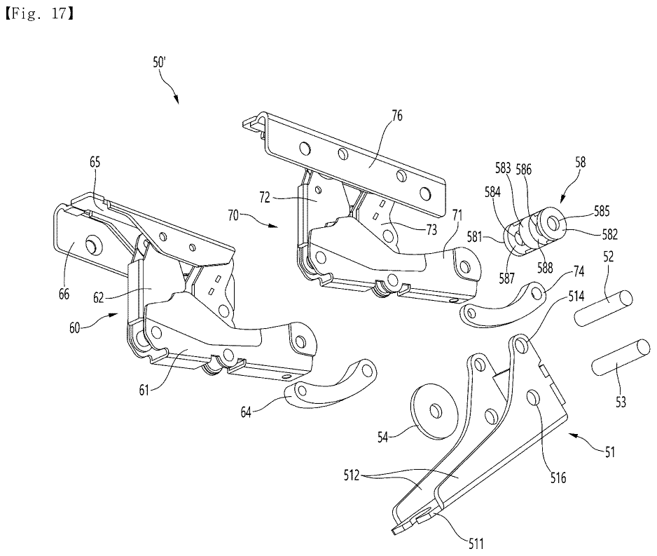

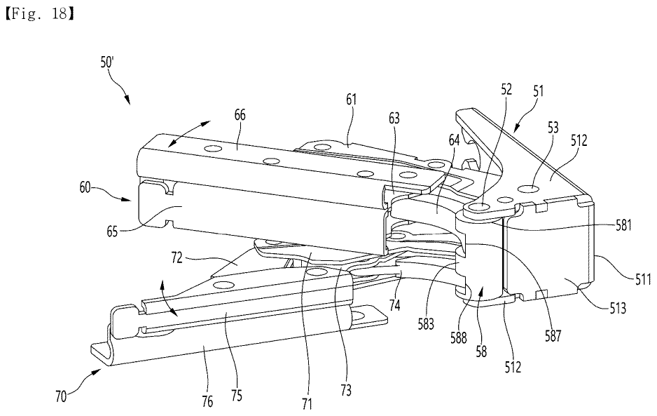

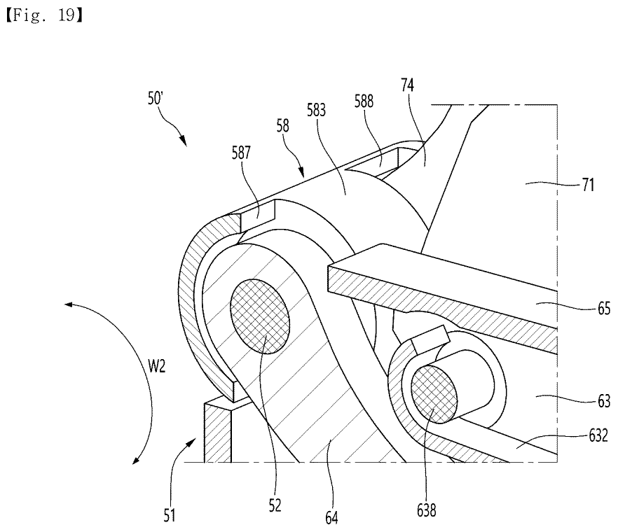

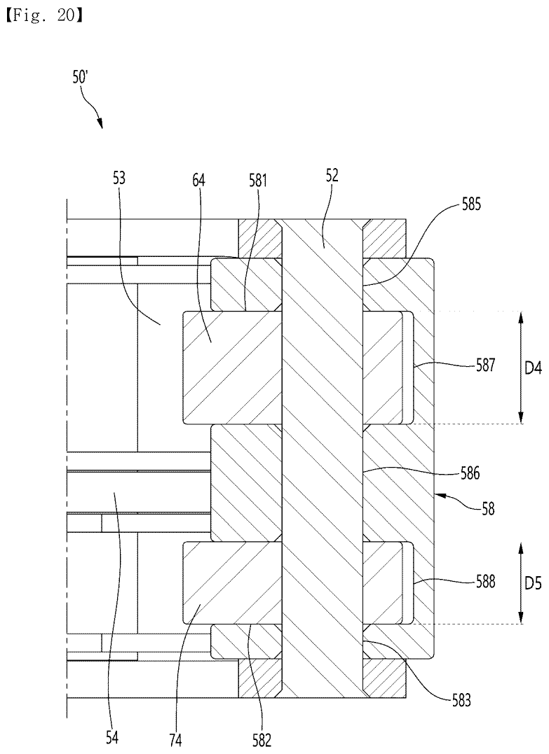

FIG. 16 is a perspective view of a center hinge according to a second embodiment of the present invention, and FIG. 17 is an exploded perspective view of the center hinge shown in FIG. 16, and FIG. 18 is a perspective view showing a partially unfolded state of the center hinge according to the second embodiment, and FIG. 19 is a cross-sectional view taken along line 19-19 of FIG. 16, and FIG. 20 is a cross-sectional view taken along line 20-20 of FIG. 16.

As illustrated, the center hinge (50′) according to the second embodiment of the present invention may include a hinge bracket (51), an upper link module (60), and a lower link module (70).

The structure of the hinge bracket (51) may be identical to that of the foregoing embodiment. The hinge bracket (51) may include a rear surface (511), a pair of side surfaces (512) extending forward from the upper and lower ends of the rear surface (511), and a shielding portion (513). The side surfaces (512) may be formed with a first shaft hole (514) and a second shaft hole (516). The first hinge shaft (52) and the second hinge shaft (53) may extend through the first shaft hole (514) and the second shaft hole (516), respectively, such that the upper link module (60) and the lower link module (70) are rotatably coupled to the hinge bracket (51).

The upper link module (60) and the lower link module (70) may have the same structure as those of the foregoing embodiment. At least a portion of the upper link module (60) and the lower link module (70) may be formed of a metallic material.

The upper link module (60) may include an upper main link (61), a first upper sub link (62), a second upper sub link (63), an upper connecting link (64), and an upper door bracket (67). The lower link module (70) may include a lower main link (71), a first lower sub link (72), a second lower sub link (73), a lower connecting link (74), and a lower door bracket (77).

A spacer (58) may be provided in the hinge bracket (51), and the upper link module (60) and the lower link module (70) may be connected to the spacer (58). The first hinge shaft (52) may extend through the spacer (58).

Specifically, the spacer (58) may be formed in a cylindrical shape and may be disposed inside the hinge bracket (51). The upper surface of the spacer (58) may contact one surface of the hinge bracket (51), and the lower surface of the spacer (58) may contact the other surface of the hinge bracket (51). In other words, the vertical height of the spacer (58) may correspond to the distance between the pair of side surfaces of the hinge bracket (51).

The spacer (58) may be formed of a material having excellent wear resistance. In addition, the spacer (58) may be formed of a non-metallic material having excellent lubrication performance. For example, the spacer (58) may be made of an engineering plastic material, and even with repeated contact with the upper link module (60) and the lower link module (70), it may not wear and may ensure stable operation of the upper and lower link modules (60, 70).

Further, the upper surface (581) and lower surface (582) of the spacer (58) may be formed with a first spacer hole (584) and a second spacer hole (585) through which the first hinge shaft (52) passes. A first connecting portion (587) and a second connecting portion (588), into which the ends of the upper connecting link (64) and the lower connecting link (74) are inserted, may be formed on the circumferential surface of the spacer (58).

The first spacer hole (584) may be formed on the upper surface of the first connecting portion (587), and the second spacer hole (585) may be formed on the lower surface of the second connecting portion (588). The first connecting portion (587) and the second connecting portion (588) may be formed to correspond to the thicknesses of the upper connecting link (64) and the lower connecting link (74), respectively. That is, the vertical height (D4) of the first connecting portion (587) may be greater than the vertical height (D5) of the second connecting portion (588). Therefore, the relatively thicker upper connecting link (64) may be received inside the first connecting portion (587).

Meanwhile, the open width (W2) of the first connecting portion (587) and the second connecting portion (588) may correspond to the rotational trajectories of the upper connecting link (64) and the lower connecting link (74). Accordingly, even when the upper connecting link (64) and the lower connecting link (74) rotate while the spacer (58) remains fixed, the spacer (58) may maintain its fixed state without interfering with the upper connecting link (64) and the lower connecting link (74). For example, the open width (W2) of the first connecting portion (587) and the second connecting portion (588) may be formed to be equal to or greater than one-half of the total circumference of the spacer (58).

Meanwhile, the first connecting portion (587) and the second connecting portion (588) may be spaced apart from each other, and an intermediate portion may be formed therebetween. The upper and lower surfaces of the intermediate portion (583) may respectively serve as the lower surface of the first connecting portion (587) and the upper surface of the second connecting portion (588). The intermediate portion (583) may be formed with a third spacer hole (586) through which the second hinge shaft (53) passes.

The first spacer hole (584), the second spacer hole (585), and the third spacer hole (586) may be positioned on the same extension line. Accordingly, by means of a single first hinge shaft (52), both side surfaces (512) of the hinge bracket (51), as well as the upper connecting link (64), the lower connecting link (74), and the spacer (58), may be penetrated and assembled together.

Meanwhile, the upper main link (61) and the lower main link (71) may be rotatably mounted to the hinge bracket (51) by means of the second hinge shaft (53). The second hinge shaft (53) may penetrate both side surfaces (512) of the hinge bracket (51) and may also extend through the upper main link (61) and the lower main link (71) inside the hinge bracket (51).

In addition, the second hinge shaft (53) may pass through the sub spacer (54). The sub spacer (54) may be positioned between the upper main link (61) and the lower main link (71), and its center may be penetrated by the second hinge shaft (53). The upper surface of the sub spacer (54) may support the lower surface of the upper main link (61), and the lower surface of the sub spacer (54) may support the upper surface of the lower main link (71), thereby maintaining a spacing between the upper link module (60) and the lower link module (70) and preventing the upper link module (60) from sagging. The structure and shape of the sub spacer (54) may be identical to those described in the foregoing embodiment.

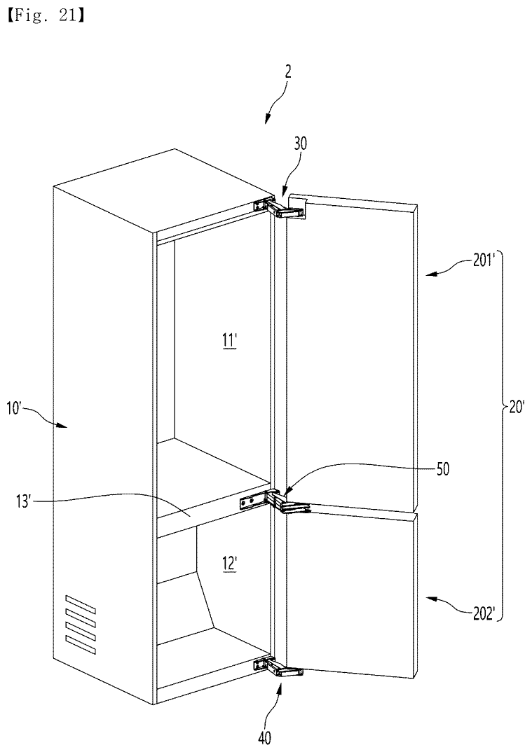

FIG. 21 is a perspective view of a refrigerator according to a third embodiment of the present invention.

As illustrated, the refrigerator (2) according to another embodiment of the present invention may include a cabinet (10′) that forms a storage space, and a door (20′) that opens and closes the storage space.

The storage space of the cabinet (10′) may be vertically partitioned by a barrier (13′), with a refrigerating compartment (11′) formed at an upper portion and a freezing compartment (12′) formed at a lower portion. The door (20′) may include a refrigerating compartment door (201′) and a freezing compartment door (202′), which open and close the refrigerating compartment (11′) and the freezing compartment (12′), respectively. The refrigerating compartment door (201′) and the freezing compartment door (202′) may be rotatably mounted to the cabinet (10′).

Further, the cabinet (10′) may be provided with an upper hinge (30), a lower hinge (40), and a center hinge (50). The structures of the upper hinge (30), lower hinge (40), and center hinge (50) may be identical to those described in the foregoing embodiments, and therefore, detailed descriptions thereof will be omitted.

The refrigerator (2) may be installed in a built-in configuration within furniture or a wall, or a plurality of refrigerators (2) may be arranged side by side laterally, or positioned adjacent to other home appliances. In such cases, the periphery of the door (20′) may be disposed very close to the furniture, wall, another refrigerator, or home appliance, thereby forming a very narrow gap.

The center hinge (50) may have the same structure as the center hinge (50) described in the foregoing embodiments. That is, the center hinge (50) may include an upper link module (60) and a lower link module (70) that are rotatably coupled to a hinge bracket (51) by means of a first hinge shaft (52) and a second hinge shaft (53). Accordingly, the upper link module (60) and the lower link module (70) may maintain a spacing therebetween and prevent sagging through the spacers (56, 57, 58) and the sub spacer (54).

In addition, even with repeated opening and closing of the door (20′), the center hinge (50) may ensure smooth operation while preventing damage caused by frictional wear and deformation due to the load of the refrigerating compartment door (201′).

The center hinge and the refrigerator having the center hinge according to an embodiment of the present invention provides the following effects.

According to an embodiment of the present invention, an upper link module and a lower link module may be mounted on a hinge bracket in a spaced-apart state by means of a spacer provided to the hinge bracket. The spacer may be formed of a wear-resistant material, and thus, even during repeated operation of the upper link module and the lower link module made of a metallic material, wear of the upper and lower link modules can be prevented, ensuring smooth operation.

In particular, the upper link module and the lower link module are operated while being inserted into the spacer. Therefore, direct contact between the upper link module and the lower link module with the hinge bracket is fundamentally prevented, and as a result, wear of the upper and lower link modules can be further reduced, thereby ensuring smooth operation.

Furthermore, a sub-spacer, which is penetrated by a second hinge shaft, may be provided between the upper link module and the lower link module. Accordingly, even when a high load is applied to the upper door, the upper link module can be prevented from contacting the lower link module. Therefore, the upper and lower link modules do not interfere with each other during operation, thereby ensuring reliable operability.

According to an embodiment of the present invention, the upper link module and the lower link module may be mounted in a spaced-apart state on a spacer provided to the hinge bracket, and the spacer may be formed of a wear-resistant material. Accordingly, even during repeated operation of the upper and lower link modules made of a metallic material, wear can be prevented, and smooth operation can be ensured.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A center hinge comprising:
a hinge bracket fixedly mounted to a cabinet of a refrigerator that is opened and closed by an upper door and a lower door;
an upper link module disposed at an upper portion of the hinge bracket, the upper link module comprising a plurality of links and configured to connect the hinge bracket and the upper door to rotate the upper door;
a lower link module disposed at a lower portion of the hinge bracket, the lower link module comprising a plurality of links and configured to connect the hinge bracket and the lower door to rotate the lower door;
a spacer provided in the hinge bracket and on which the upper link module and the lower link module are mounted; and
a first hinge shaft passing through the hinge bracket, the upper link module, the lower link module, and the spacer, and configured to enable rotation of the upper link module and the lower link module,
wherein the upper link module and the lower link module are inserted into the spacer in a state spaced apart from the hinge bracket.

2. The center hinge according to claim 1,
wherein at least a portion of the upper link module and the lower link module is made of a metal material, and
the spacer is made of a non-metal material.

3. The center hinge according to claim 1,
wherein the hinge bracket comprises:
a rear surface coupled to the cabinet; and
a pair of side surfaces extending forward from upper and lower portions of the rear surface, and
wherein the spacer has an upper surface and a lower surface respectively contacting the pair of side surfaces.

4. The center hinge according to claim 1,
wherein the spacer comprises:
an upper spacer on which the upper link module is mounted; and
a lower spacer disposed below the upper spacer and on which the lower link module is mounted,
wherein the upper spacer and the lower spacer are configured to rotate independently of each other.

5. The center hinge according to claim 4,
wherein the first hinge shaft sequentially passes through the upper spacer and the lower spacer, and penetrates the upper link module and the lower link module that are inserted into the upper spacer and the lower spacer.

6. The center hinge according to claim 4,
wherein the upper link module rotates together with the upper spacer in a coupled state, and
the lower link module rotates together with the lower spacer in a coupled state.

7. The center hinge according to claim 4,
wherein a first upper hole and a second upper hole, through which the first hinge shaft passes, are formed on an upper surface and a lower surface of the upper spacer, respectively, and
a first lower hole and a second lower hole, through which the first hinge shaft passes, are formed on an upper surface and a lower surface of the lower spacer, respectively, and
wherein, in a state in which the upper spacer and the lower spacer are coupled, the first upper hole, the second upper hole, the first lower hole, and the second lower hole are arranged on the same extension line.

8. The center hinge according to claim 7,
wherein a rotational coupling portion protruding along a periphery of the second upper hole is formed on a lower surface of the upper spacer, and
a coupling groove recessed along a periphery of the first lower hole is formed on an upper surface of the lower spacer, and
wherein, when the upper spacer is seated on the upper surface of the lower spacer, the rotational coupling portion is inserted into the coupling groove to be rotatably coupled.

9. The center hinge according to claim 8,
wherein an upper connection portion opened to allow insertion of the upper link module is formed on a periphery of the upper spacer, and
a lower connection portion opened to allow insertion of the lower link module is formed on a periphery of the lower spacer, and
wherein the upper connection portion and the lower connection portion are each formed in a size corresponding to an insertion portion of the upper link module and the lower link module, respectively.

10. The center hinge according to claim 9,
wherein the upper connection portion is in communication with the first upper hole and the second upper hole, and
the lower connection portion is in communication with the first lower hole and the second lower hole.

11. The center hinge according to claim 4,
Wherein the upper link module is formed thicker than the lower link module, and
a vertical height of the upper spacer is formed greater than a vertical height of the lower spacer.

12. The center hinge according to claim 1,
wherein an upper surface of the spacer is in contact with an upper surface of the hinge bracket, a lower surface of the spacer is in contact with a lower surface of the hinge bracket, and
a periphery of the spacer is opened with a first connection portion into which the upper link module is inserted and a second connection portion into which the lower link module is inserted.

13. The center hinge according to claim 12,
wherein a vertical height of the first connection portion is formed greater than a vertical height of the second connection portion.

14. The center hinge according to claim 12,
wherein an intermediate portion is formed between the first connection portion and the second connection portion to maintain a predetermined distance between the upper link module and the lower link module, and
the first hinge shaft penetrates the intermediate portion.

15. The center hinge according to claim 12,
wherein the spacer has its upper and lower surfaces fixed to the hinge bracket, and the upper link module and the lower link module are rotatable within the first connection portion and the second connection portion, respectively.

16. The center hinge according to claim 15,
wherein an opening width of the first connection portion and the second connection portion is formed to correspond to rotational trajectories of the upper link module and the lower link module.

17. The center hinge according to claim 1,
further comprising a second hinge shaft penetrating the hinge bracket,
wherein the second hinge shaft penetrates another side of the upper link module and the lower link module at a position spaced apart from the first hinge shaft and the spacer.

18. The center hinge according to claim 17,
further comprising a sub spacer disposed between the upper link module and the lower link module,
wherein the sub spacer is penetrated by the second hinge shaft, and
the sub spacer is formed in a plate shape that contacts a lower surface of the upper link module and an upper surface of the lower link module.

19. The center hinge according to claim 18,
wherein the sub spacer is formed in a disc shape, and
a radius of the sub spacer is smaller than a distance from the first hinge shaft to an inner surface of the hinge bracket and an outer surface of the spacer.

20. A refrigerator comprising:
a cabinet having an upper storage compartment and a lower storage compartment partitioned by a barrier;
an upper door for opening and closing the upper storage compartment;
an upper hinge connecting an upper end of the upper door to the cabinet;
a lower door for opening and closing the lower storage compartment;
a lower hinge connecting a lower end of the lower door to the cabinet; and
a center hinge disposed between the upper door and the lower door,
wherein the center hinge comprises:
a hinge bracket mounted to the barrier;
an upper link module disposed above the hinge bracket and configured a plurality of links to connect the hinge bracket to the upper door and to rotate the upper door;
a lower link module disposed below the hinge bracket and configured a plurality of links to connect the hinge bracket to the lower door and to rotate the lower door;
a spacer provided in the hinge bracket and on which the upper link module and the lower link module are mounted; and
a first hinge shaft penetrating the hinge bracket, the upper link module, the lower link module, and the spacer, and configured to rotate the upper link module and the lower link module,
wherein the upper link module and the lower link module are inserted into the spacer in a state spaced apart from the hinge bracket.
